(19) United States
(12) Patent Application Publication
(10) Pub. No.: US 2014/0358661 A1
(43) Pub. Date: Dec. 4, 2014

(54) LOCATION AND TRANSACTION-BASED MULTI-BRAND LOYALTY SERVICE

(71) Applicant: VMobo, Inc., Bangalore (IN)

(72) Inventors: Yan Or, San Francisco, CA (US); Anand Kumar Sankaran, Fremont, CA (US); Madhu Gopinathan, Bangalore (IN); Vinu Sundaresan, Fremont, CA (US)

(21) Appl. No.: 13/903,887

(22) Filed: May 28, 2013

(51) Int. Cl. G06Q 30/02

(52) U.S. Cl. CPC G06Q 30/0226
USPC 705/14.27

(57) ABSTRACT

A multi-brand loyalty server provides real-time product or service suggestions to customers based on transaction data. The multi-brand loyalty server receives customer information and transaction data from a merchant device(s) located at a merchant subscriber's premises. A loyalty event, such as a promotion or reward for a suggested product or service, is determined based on the transaction data. Information about a suggested merchant and the loyalty event is sent to a mobile device operated by the customer in order to encourage him to make a purchase from the suggested merchant.

### BACKGROUND

This invention relates generally to computer generated recommendations for consumers and, in particular, to generating consumer recommendations for a multi-brand network of merchants based on location data and transaction data.

Advertisers and marketers today often target consumers with marketing messages containing information about products and services, where the messages are tailored for those consumers based on their purchasing patterns. For example, a retailer may track the purchases made by a consumer, and may predict products that are likely to be bought by the consumer in the future based on this data. Coupons for these predicted products may be sent in an email message to the consumer to entice them to buy more products from the retailer. Such targeted marketing can be effective for some classes of products since consumer purchasing patterns may be predictable for those classes of products.

However, these sorts of marketing techniques are less effective for some classes of products and services because consumer interest in related products and services may be very time and location sensitive. For example, when consumers dine at a restaurant they may often be in the market for a movie afterwards. However, sending a movie ticket through email to the consumers may be ineffective for various reasons. First, the coupon for the movie ticket may not be of interest to the consumer if the movie theater is not proximate to the restaurant. Second, a coupon for a movie ticket sent through email to the consumer may not be seen by that consumer until later (say the next day), in which case the coupon would not be as effective in enticing the consumer to a specific theater as one that is delivered while or shortly after the consumer is dining at the restaurant.

Thus there is a need for a technology that can deliver product and service recommendations within time and location constraints that provide relevance to the consumer.

### SUMMARY

A network of merchants subscribe to a multi-brand loyalty service. A multi-merchant loyalty server system provides loyalty events (such as product or service suggestions) to customers in real-time. Since the network contains multiple merchants and brands, the loyalty events can cross-sell between merchants and brands. The real-time delivery of the loyalty events allows these offerings to take advantage of time and/or geographic proximity to customer transactions within the multi-merchant network.

In one implementation, the multi-brand loyalty server system receives customer identification and transaction data from device(s) located on a merchant subscriber's premises. For example, if a customer is making a transaction, the customer might present a membership card that is swiped through a merchant device to identify the customer. Information about the actual transaction may also be captured by a merchant device. The multi-brand loyalty server system receives both the customer identification and the transaction data. The multi-brand loyalty server system uses the transaction data to determine a suggested product or service (or other loyalty event) that is predicted to be relevant to the customer at the current time and at the customer's current location. The geographic location of the customer may be determined based on a location associated with the merchant subscriber. For example, the multi-brand loyalty server may determine a search vicinity for the customer based on his current geographic location and then determine a merchant subscriber within the search vicinity who offers the suggested product or service. The multi-brand loyalty server sends a real-time notification about the suggested product or service and the suggested merchant (or other loyalty event) to the customer's mobile device, such as his cell phone. The information may include coupons or other inducements to encourage the customer to make a purchase from the suggested merchant.

Other aspects of the invention include methods, devices, systems, applications and other technology related to any of the foregoing.

### BRIEF DESCRIPTION OF THE DRAWINGS

FIG. 1 is a block diagram of a multi-merchant loyalty network.

FIG. 2 is a flow diagram for providing loyalty services to customers in the multi-merchant loyalty network.

FIG. 3 is a block diagram of one embodiment of a multi-brand loyalty server.

FIG. 4 is a block diagram of one embodiment of a recommendation module.

FIG. 5 is a block diagram of one embodiment of a search module.

FIGS. 6A-6B are diagrams illustrating different ways to register members.

FIGS. 7A-7C are diagrams illustrating different ways to provide loyalty events.

FIG. 8 is a diagram illustrating an example of reporting.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

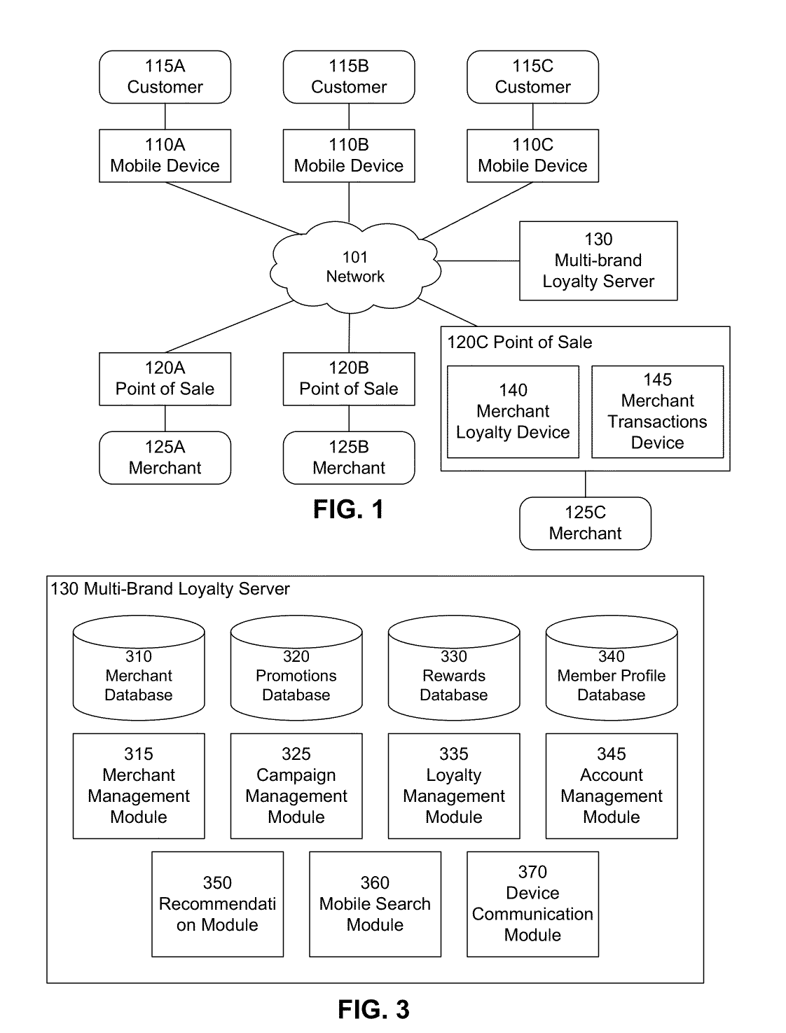

Figure (FIG. 1) illustrates a multi-brand loyalty server 130 operating in a networked environment. Here the multi-brand loyalty server 130 is connected via a network 101 with a plurality of customers 115 using mobile devices 110 and a plurality of merchants 125 through point of sale devices 120. The merchants have subscribed to a loyalty service, the purpose of which is to drive traffic between the different merchant subscribers. That is, to build “brand” loyalty to the network of merchants. This type of loyalty service is different from conventional offerings because it spans multiple merchants/brands.

The mobile devices 110 may be portable device with the ability to communicate with the multi-brand loyalty server 130, such as smart phones, tablets, cell phones, etc. A customer 115 operating a mobile device 110 can receive and view messages from the multi-brand loyalty server 130. The messages may be communicated in real-time to the mobile device 110 through any applicable communication means, including through Short Message Service (SMS), email, mobile application (app), etc. The notification from the multi-brand loyalty server 130 contains marketing information promoting a product or service offered by one or more suggested merchants (which will generally be referred to as “loyalty events”), and the loyalty events are predicted to be relevant to the user at the current time and location. Based on the information in the messages, the user hopefully is motivated to visit one or more of the suggested merchants to take advantage of one or more of the loyalty events. The messages may take the form of advertisements, coupons with discounts or other promotions to motivate action from the user. Since the loyalty events are delivered in real-time, they may also be time-limited to motivate immediate action from the user.

Before being able to receive and view messages from the multi-brand loyalty server 130, a customer 115 may need to register or subscribe to a multi-brand loyalty service. After subscribing, the customer may obtain a membership card used to identify the customer when making a transaction or redeeming a promotion or reward.

The point of sale devices 120 are operated by merchants such as product retailers, service providers, etc., who have subscribed to the loyalty service. The point of sale devices 120 may be any device capable of sending data to the multi-brand loyalty server 130, such as, for example, personal computers, dedicated point of sale devices (e.g., credit card readers), tablets, electronic cash registers, vending machines, etc.

The point of sale devices 120 send transaction data containing information about transactions conducted between users and merchant subscribers, to the multi-brand loyalty server 130. The transaction data is sent from the point of sale device 120 to the multi-brand loyalty server 130 as the transaction is conducted between the user and the merchant subscriber, or soon after the transaction has been completed. In this way the multi-brand loyalty server 130 is given real-time or nearly real-time information about a transaction. In some embodiments, the multi-brand loyalty serve 130 receives transaction data from a merchant subscriber 125 within a threshold amount of time (e.g., 1 minute) after the transaction between the merchant subscriber 125 and the customer 115 has been completed. The transaction data may contain information describing products and services that have been purchased by the user in the transaction with the merchant subscriber. The transaction data may also identify the location of the store where the transaction took place, or the multi-brand loyalty server may determine this based on other information, such as information provided by the merchant at registration for the loyalty service.

The point of sale devices 120 also provide customer identification to the multi-brand loyalty server 130. For example, customers may present a membership card, a membership number, a barcode of the membership number, a phone number, or other loyalty service identification. For convenience, the device that provides transaction data will be referred to as the merchant transaction device 145 and the device that provides customer identification will be referred to as the merchant loyalty device 140. This is strictly for purposes of explanation. The merchant transaction device 145 and the merchant loyalty device 140 could be implemented by a single device rather than as two separate devices.

The network 101 provides a communication infrastructure between the mobile device 110, the point of sale devices 120, and the multi-brand loyalty server 130. The network 101 may include cellular networks, the Internet, a Local Area Network (LAN), a Metropolitan Area Network (MAN), a Wide Area Network (WAN), a mobile wired or wireless network, a private network, a virtual private network, etc.

The multi-brand loyalty server 130 receives transaction data from the point of sale devices 120 and generates messages containing product or service promotions for suggested merchants that are sent back to the mobile device 110 in real-time. These messages may be in the form of advertisements, coupons, mobile alerts, etc. The messages may be sent to the user devices as SMS (text), email, through a mobile app, or any other mobile communication method. Details of the multi-brand loyalty server are described in conjunction with the description for FIG. 3.

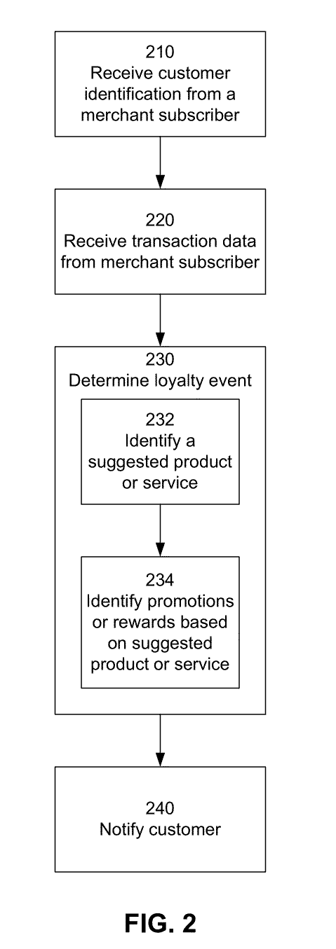

FIG. 2 illustrates an example process used by the multi-merchant loyalty server 130 to provide loyalty services to customers 115, according to one embodiment. In the illustrated process, the multi-brand loyalty sever 130 receives 210 customer identification from a merchant subscriber 125. In one embodiment, the merchant subscriber 125 obtains the customer information by scanning or swiping a membership card. In other embodiments, the merchant subscriber 125 may ask a customer 115 for identification information such as phone number, address, driver license number, and the like. In yet other embodiments, the customer identification may be derived from the payment method used by the customer 115, such as a credit card number. Embodiments of the invention may use a merchant loyalty device 140, located on premises at the merchant subscriber 125, to retrieve the customer identification and send the customer identification to the multi-brand loyalty server 130. In one embodiment, the merchant loyalty device is embedded in, or is part of, the point of sale device 120.

Transaction data is also received 220 from the merchant subscriber 125. Transaction data may comprise one or more products or services purchased by the customer 115. Transaction data may also comprise information related to the merchant subscriber 125 where the customer 115 made the transaction. In some embodiments, the transaction data is sent from a merchant transaction device. In one embodiment, the merchant transaction device is embedded in, or is part of, the point of sale device 120.

The multi-brand loyalty server 130 determines 230, in real-time, a loyalty event. Examples of loyalty events include promotions and rewards. Examples of promotions are a price deal, a coupon, rebate, or the like, that the customer 115 can use at a second merchant subscriber to obtain a product or service at a discounted price. For example, a promotion may be a coupon for a 50% discount at another specific merchant subscriber 125. Promotions may be specific to one or more merchants, one or more products at any merchant subscriber that offers the product, or one or more products in a specific merchant subscriber, etc.

One type of reward is a redeemable offer in which the customer can use points or stars that were obtained for purchasing products or services at one or more merchant subscribers 125. Rewards may also be specific to one or more merchants, one or more products at any merchant subscriber offering the product, or one or more products in a specific merchant subscriber. Promotions and rewards may need to be used or redeemed within a certain amount of time (e.g., within 24 hours) of the transaction between the merchant subscriber 125 and the customer 115.

In one embodiment, the loyalty event is for a merchant subscriber 125B different from the merchant subscriber 125A where the customer is currently making a transaction. The merchant subscriber 125B associated with the loyalty event may be selected based on its geographic relation with merchant subscriber 125A (e.g., based on a distance between the two merchant subscribers, or whether both merchants are located in the same mall). In other embodiments, the loyalty event is for a product at the current merchant subscriber 125A to entice the customer 115 to keep shopping at that merchant subscriber.

In some embodiments, the loyalty event may be information regarding a product or service at a second merchant subscriber, where the product or service is related to the transaction between the merchant subscriber 125 and the customer 115. In some embodiments, the loyalty event may include information regarding a product that is only available to customers using the multi-brand loyalty service.

To determine 203 the loyalty event, the multi-brand loyalty server 130 may identify a suggested product or service. In some embodiments, the identification of the suggested product or service is based on the received customer identification, transaction data, and/or information derived from the customer identification and/or transaction data. The multi-brand loyalty server 130 then identifies 234 promotions or rewards based on the identified suggested product or service.

The multi-brand loyalty server 130 notifies the customer of the identified promotions or rewards. In one embodiment, the multi-brand loyalty server 130 notifies 240 the customer via SMS. In other embodiments, the multi-brand loyalty server 130 may use different communication channels such as email, or a push notification through an application running on the mobile device 110 used by the customer 115.

### Multi-Brand Loyalty Server

FIG. 3 is a block diagram of one embodiment of a multi-brand loyalty server. In the illustrated embodiment, the multi-brand loyalty server 130 includes a device communication module 370, a recommendation module 350, a mobile search module 360, an account management module 345, a member profile database 340, a merchant management module 315, a merchant database 310, a campaign management module 325, a promotions database 320, a loyalty management module 335 and a rewards database 330.

The device communication module 370 handles communication with the mobile devices 110 and the point of sale devices 120. The device communication module 370 enables the multi-brand loyalty server 130 to perform common communications-related operations on messages that are sent and received, such as encryption/decryption, compression/decompression, authentication, etc. Transaction data from point of sale devices 120 is received by the device communication module 370 and sent to the recommendation module 350. Notifications of loyalty events (e.g., messages with product recommendations) generated by the recommendation module 350 are sent by the device communication module 370 to the mobile devices 110.

The account management module 345 enables users operating the mobile devices 110 to establish a user account with the multi-brand loyalty server 130 and is configured to update the member profile database 340. The account management module 345 may receive information about users operating the mobile devices 110, either from the mobile devices 110 or from other sources such as directories, retailers, credit agencies, banks, etc. Some user information may be provided by users when they register or establish an account with the multi-brand loyalty server 130. Other information may be collected passively by the account management module 345 over the course of time, for example as transaction data concerning a user is sent to the multi-brand loyalty server 130 from merchant subscribers.

The member profile database 340 stores information about users that has been received or collected by the account management module 345. Information about a user may be aggregated and stored by the account management module 345 in a user profile for that user. The user profile for a user may contain information about the user such as age, sex, address, product preferences, store preferences, purchase history, stores frequented, etc.

The merchant management module 315 enables merchants to establish an account with the multi-brand loyalty server 130. Merchants that subscribe to the loyalty service (which usually requires them to register or otherwise establish an account with the multi-brand loyalty server 130) are referred to as merchant subscribers. In one embodiment, the network of merchant subscribers are limited to merchants located within a certain geographic area (such as a certain city, or metropolitan area). In other embodiments, the merchant network is limited to merchants that offer luxury brands and/or luxury services.

The merchant subscribers operate the point of sale devices 120 that send transaction data to the multi-brand loyalty server 130. When a merchant subscriber establishes an account with the multi-brand loyalty server 130, the merchant management module 315 receives business information from the merchant subscriber. The business information provides a description of the merchant's business that can be used to determine when users should be directed to that merchant. For example, the business information provided to the multi-brand loyalty server 130 may include information about products or services offered by the merchant, locations for stores operated by the merchant, store hours for the merchant, etc. The information for each merchant subscriber is stored in records in the merchant database 310. The merchant management module 315 may also receive information from merchant subscribers describing advertisements, coupons, and other inducements offered by those merchants. When it is determined that a user may be interested in products or services offered by a particular merchant subscriber, that merchant's coupons or advertisements may be sent in a message to the customer. The process for determining when to send a particular merchant's information to a user is described in more detail herein.

The recommendation module 350 receives transaction data about a transaction between a user and a merchant subscriber, from a point of sale device 120 operated by that merchant, and generates a message containing promotional information about a product or service offered by a suggested merchant, which is relevant to the user and which can be sent in real-time to a mobile device 110 operated by the user. The communication to and from the mobile device 110 and point of sale device 120 can be conducted via the device communication module 370, as described earlier, and can take the form of emails, SMS messages, push notifications through a mobile app, etc. The recommendation module 350 typically utilizes information in the member profile database 340 and the merchant database 310, in addition to the transaction data and the customer identification, to determine the product or service that is relevant to the user. The recommendation module 350 is discussed in more detail below.

The mobile search module 360 indexes documents (such as promotions or rewards offered by merchant subscribers) and maintains a content index. When search queries are received from mobile devices 110 operated by customers 115, the mobile search module 360 identifies query results that are referenced to indexed documents that are relevant to the query strings. The query results may be sent back to the mobile device 110 via the device communication module 370.

The promotion database 320 stores information about promotions offered by merchant subscribers through the multi-brand loyalty server 130. Information about promotions may include a description of the promotion, a time frame during which the promotion is valid, a targeting criteria limiting which users are eligible to receive the promotion, etc.

The rewards database 330 stores information about rewards offered by merchant subscribers or by the loyalty service through the multi-brand loyalty server 130. Information about rewards may include a description of the reward, a number of loyalty points or stars required to redeem the reward, a time frame during which the reward is valid, etc. The promotion database 320 and the reward database 330 are updated by the campaign management module 325.

The loyalty management module 335 updates an amount of points or stars available to each customer based on transaction data received from merchant subscribers. In some embodiments, the loyalty management module 335 increases the number of points or stars available to a customer each time the customer performs a transaction using the multi-brand loyalty service, and the loyalty management module 335 decreases the number of points or stars available to the customer each time the customer uses their available points or stars to take advantage of a reward offered by a merchant subscriber. For example, the loyalty management module 335 may increase the amount of points a customer has by one point for every dollar the user spends using the multi-brand loyalty service. As another example, the loyalty management module 335 may decrease a certain amount of points (e.g., 1000 points) when the customer redeems a movie ticket using a reward offered by a movie theater.

### Generating Location and Transaction-Based Recommendations

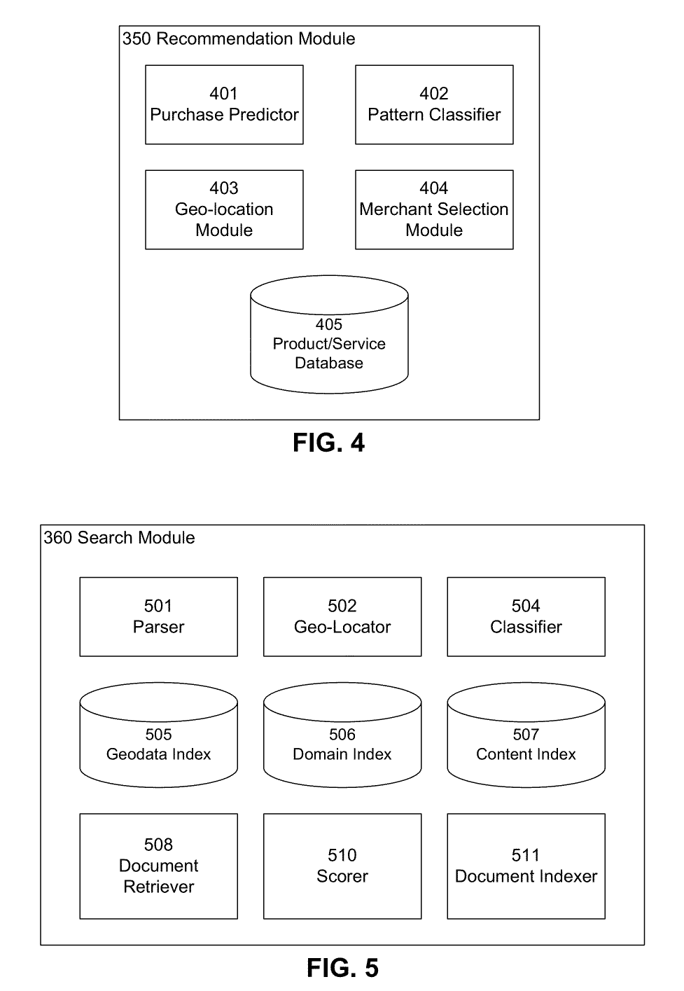

FIG. 4 illustrates a detailed view of the components of the recommendation module 350, according to one embodiment. In the illustrated embodiment, the recommendation module 350 includes a purchase predictor 401, a pattern classifier 402, a geo-location module 403, a merchant selection module 404, and a product/service database 405.

The purchase predictor 401 uses information in the transaction data received from a merchant 125 to determine a suggested product or service that will be relevant to the user in the immediate future. The purchase predictor 401 uses the product/service database 405 and the pattern classifier 402 to determine a product or service that is likely to be purchased by a user based on their recent purchases.

In some embodiments, the purchase predictor 401 determines a suggested product or service based on the identity of a merchant subscriber providing transaction data. In other embodiments, the suggested product or service is determined based on the type of business transacted by the merchant subscriber providing transaction data.

The product/service database 405 includes records containing information describing various products and services available in the market. The record for a product or service may contain data such as price information, references to related products and services within the database, as well as references to merchant subscriber records in the merchant database 310 for merchants that offer the product or service for sale. The record for a product or service may also contain an expected maximum travel distance that describes the largest expected distance that a consumer would travel to purchase that product or service. For example, simple goods such as candy, soda, snacks, etc., may have a relatively small expected maximum travel distance, say 1000 yards, since consumers are not expected to be willing to travel far to buy such goods. On the other hand, an expensive product such as a television, automobile, or boat, may have a relatively large expected maximum travel distance, say 50 miles, since consumers may be willing to travel greater distances to obtain a better price or match.

The pattern classifier 402 takes the information about a user's recent purchases, from the transaction data, as input, along with information from the user's profile (such as purchase history, demographic information, etc.), and selects a product or service from the product/service database 405 that is predicted to be currently relevant to the user. In one embodiment, the pattern classifier 402 is a statistical model that is developed by the entity operating the loyalty service. In another embodiment the pattern classifier 402 is a machine-learned model that is trained to predict the purchasing patterns of consumers based on historical purchase data of users.

In some embodiments, the pattern classifier 402 selects a product or service based on aggregate transaction data received for many customers and/or many transactions. For example, the pattern classifier 402 may determine that the product “popcorn” is very relevant for a customer that just purchased a ticket to watch a movie, based on the number of customers that purchased popcorn after purchasing a ticket to watch a movie.

In one embodiment, the aggregate data is specific to a certain merchant subscriber (e.g., transaction performed between a plurality of customers and a specific merchant subscriber). For example, the pattern classifier 402 may predict which is the most relevant product or service for a customer after performing a transaction at a specific merchant subscriber by determining which other transactions customers performed after performing the transaction with the specific merchant subscriber.

The geo-location module 403 determines a geographical location for a user, for example based on transaction data received from a point of sale device 120, and then determines a search vicinity for the user. The geographical location for the user may not be the exact location of the user, but rather may be an approximate location that is determined based on the location of a merchant store where a transaction took place or a merchant device that is providing transaction data or customer identification. The advantage of this approach is that a location for a user may be determined even when the mobile device 110 operated by the user does not possess geo-locating capabilities or even when the geo-locating capabilities of the mobile device 110 are not able to determine the location of the user (e.g., because user is in an enclosed structure, such as a shopping mall). In one embodiment, the geo-location module 403 fixes the approximate geographical location of the user based on location data that is included in the transaction data received by the multi-brand loyalty server 130 from the point of sale device 120. In another embodiment, the transaction data includes an identifier for the merchant subscriber and/or the store where the transaction occurred, and the geo-location module 403 accesses a corresponding record in the merchant database 310 to determine a geographical location associated with the merchant and/or the store in the record.

The search vicinity is a geographical zone around the user's current estimated location within which suggested merchants are expected to be relevant to the user. For example, a search vicinity might be an area within a certain radius of a merchant subscriber. Merchants outside the search vicinity are not expected to be relevant to the user because they are too far from the user's current estimated location. Once the geographical location is determined, the search vicinity can be determined by estimating the zone within which the user is expected to travel to shop in the near future.

The search vicinity is determined by the geo-location module 403 based on any number of factors. For example, it typically will take into account the geographical location for the user and the suggested product or services from the product/service database 405 that has been identified as relevant for the user by the purchase predictor 401. For example, if the suggested product identified by the purchase predictor 401 is an item with a relatively small expected maximum travel distance, the search vicinity will include only a small area around the user's geographic location. Determination of the search vicinity may also take into account, the identity of the customer or his past behavior, the customer's recent transaction data, the merchants involved and/or the types of products and services involved.

If the geographic location of the user is associated with a known structure/area that is known to constrain user movement, such as, for example, a mall, railway station, airport, etc., the search vicinity can be conformed to the known structure/area. This improves the selection of suggested merchants since users do not typically leave a structure/area such as a mall for minor purchases such as drinks, snacks, etc.

The merchant selection module 404 selects a suggested merchant for a user from the merchant database 310 based on the suggested product or service and the search vicinity. To select a merchant from the merchant database 310, the merchant selection module 404 may access the records of a plurality of merchant subscribers to determine candidate merchants that offer the suggested product or service. The merchant selection module 404 may then select a candidate merchant that is associated with a location within the search vicinity as the suggested merchant. If multiple candidate merchants are present within the search vicinity, a suggested merchant can be selected on the basis of other information such as the price of the suggested product or service, the value of coupons or promotions offered by the candidates, the distance between the geographical location of the user and the candidate merchants, etc.

Once a merchant is selected, a notification containing information about the selected product or service can be sent by the recommendation module 350 to the mobile device 110 operated by the user. The message may contain information about the suggested merchant from the merchant database 310, such as, for example, an address for a store of the merchant, a coupon for the suggested product or service, etc.

### Generating Location Based Search Results

FIG. 5 illustrates a detailed view of the components of the mobile search module 360, according to one embodiment. In the illustrated embodiment, the mobile search module 360 comprises a parser 501, a geo-locator 502 a classifier 504, and a scorer 510, as well as a geodata index 505, domain index 506, and content index 507.

The parser 501 processes queries (query strings) received from the mobile device 110 and generates a sequence of tokens. The tokens are words or sequences of words that correspond to concepts that may be relevant to the generation of query responses. For example, the words “New” and “York” are tokens, and the sequence “New York” is also a token. Generating tokens from strings can be done using different techniques. These techniques are well known in the art. For example the system may use a dictionary-based approach for tokenizing the query. In the dictionary-based approach the words in the query are matched against words (tokens) in a premade dictionary to determine the words that are valid tokens. The parser 501 may also be used to generate tokens from content documents that are indexed by the mobile search module 360. The indexing of content documents is described in more detail herein.

The geo-locator 502 takes tokens as input (e.g. the tokens of a query string or document) and determines a real-world location associated with those tokens. The geo-locator 502 utilizes a geodata index 505 to perform this task. The geodata index 505 comprises a list of points of interest. Each point of interest entry in the geodata index 505 comprises location tokens indicating names for that point of interest, geo-location information for the point of interest—such as latitude/longitude coordinates—and granularity for the point of interest. A single point of interest may have multiple location tokens associated with it. For example, the country United States of America may correspond to multiple location tokens, including “America”, “United States”, “USA”, etc. The granularity of a point of interest is an indication of the scale associated with that point of interest. For example, the point of interest for San Francisco may be associated with the granularity “City.” Similarly, the point of interest California may be associated with the granularity “State,” while the point of interest America may be associated with the granularity “Country.” A complete entry for the point of interest San Francisco in the geodata index 505 might include the token “San Francisco,” and/or some other synonyms, such as “Frisco” or “San Fran,” as well as location coordinates, such as, for example, “−31.425, −62.084”, and granularity “City.”

To determine a location associated with a query the geo-locator 502 matches tokens outputted by the parser 501 for that query against the location tokens of points of interest stored in the geodata index 505, and selects a best matching point of interest based on 1) the number of tokens that match between the query tokens and the location tokens of a points of interest in the geodata index 505; and 2) the granularity of a points of interest—the more fine grained the granularity of a point of interest, the better a match it is considered (e.g. a point of interest that has a granularity of “City” is better than a point of interest that has a granularity of “Country”. The geo-location for the best matching point of interest in the geodata index 505 is used as the location for the query when determining a query response.

The classifier 504 takes the tokens outputted by the parser 501 and using the domain index 506 can determine a classification for a query or document based on those tokens. For example, if a query string is “NY pizza restaurants in San Francisco,” the classifier 504 can determine that the query is related to the classifications “restaurants” and “pizza”. Similarly the classifier 504 may classify documents that are indexed in the content index 507 by processing the tokens that have been produced from the documents by the parser 501.

The classifier 504 uses a domain index 506 to determine the classification (or topic) to which a query string or document relates to in a particular domain. A domain index 506 is useful in determining the classification of a query for a single domain. Separate domains will have different domain indexes 506. For instance, there may be a single domain index 506 to handle queries related jewelry stores, while there may be a separate domain index 506 to handle queries related to restaurants.

A domain index 506 comprises a list of classifications for a domain, as well as standard and domain-specific features for each of those classifications. The classifications are categories of contents that are relevant for a domain. For example, if the domain is automobile dealerships, the classifications may be car sales, truck sales, new car, etc. The features are characteristics of queries and documents in the domain. The features may be standard, as in not domain-specific, or domain-specific. For example, if the domain is restaurants, the features may be genre, price range, etc. A domain index 506 also contains a list of attributes for each feature that are possible values for that feature. For example, for the genre feature, the attributes may be Chinese, Indian, Italian, Mexican, etc.

The classifier 504 compares tokens in the query string to attributes and features in the domain index 506, to determine a classification for the query. For example, if the query contains tokens such as “Ring”, “diamond”, “1 carat”, the classifier 504 may use this information to classify the query as a “jewelry store” search query.

A content index 507 is a database containing indexed documents (e.g., promotions and/or rewards) for a domain, which is used to determine query responses. A content index 507 comprises a list of documents, where each document is associated with attributes, a geo-location, document contents, and one or more classifications. For example, for the domain “restaurant”, the content index 507 may contain a list of restaurants with associated data. In this content index 507, one restaurant may have, for instance, an associated classification “Italian restaurant”, with the attributes “pizza”, “pasta”, to indicate that the restaurant specializes in pizzas and pasta. This restaurant may also be associated with a geo-location indicating the address where the restaurant is located. The document indexer 511 generates a content index 507 for a domain by processing raw data (such as the description of a promotion or reward) and creating a domain specific database for the content in that raw data.

The scorer 510 generates relevance scores for locations and documents, which influences how locations and documents are determined for query responses. The relevance scores are a measure of the predicted relevance of a location or document to the query. The process for generating a relevance score may depend on the values of classifications, features, and attributes that have already been determined for a query or document. The scorer 510 is used by the geo-locator 502 and the classifier 504.

The geo-locator 502 uses the scorer 510 to determine relevance scores for location tokens matched in the geodata index 505. For example, a single query may include more than one query token that is matched in the geodata index 505. When multiple location tokens are matched in this way, the geo-locator 502 may set the target location for the query to the location associated with the highest scored, i.e. most relevant, location token. The scorer 510 can computes a relevance score for location tokens based on information about those tokens stored in the geodata index 505. For example, location tokens associated with smaller granularity points of interest may be deemed more relevant than those associated with larger granularity points of interest, or vice versa, depending on the classification of the query. Similarly information about the user from the member profile database 340 may be used to determine the relevance of a location token. For example, location tokens corresponding to points of interest close to a user's set default search location may be scored more highly than other location tokens. Finally, the characteristics of the query string itself may influence the relevance score for a location token. For example, the position in the query string of a location token can influence the relevance score for that location token (e.g. tokens at the end of the query string may be weighted higher because of the way English language queries are typed by users).

The scorer 510 is also used by the document retriever 508 to determine a document that can be sent as a response to a query. The document retriever 508 determines a query response document for a query by using the scorer 510 to determine a relevance score for each of a plurality of query response candidates (candidate documents), and selecting the candidate with the highest relevance score. The relevance score for a document that is a candidate query response can be determined based on factors such as distance between the location associated with the candidate document and a target location associated with the query, user profile information for the user that issued the query, the query's classification, attributes determined for the query, etc. A more detailed description of the process for selecting a query response document is given in U.S. patent application Ser. No. 13/765,634, filed Feb. 12, 2012, which is hereby incorporated by reference in its entirety.

### Examples of Network Operation

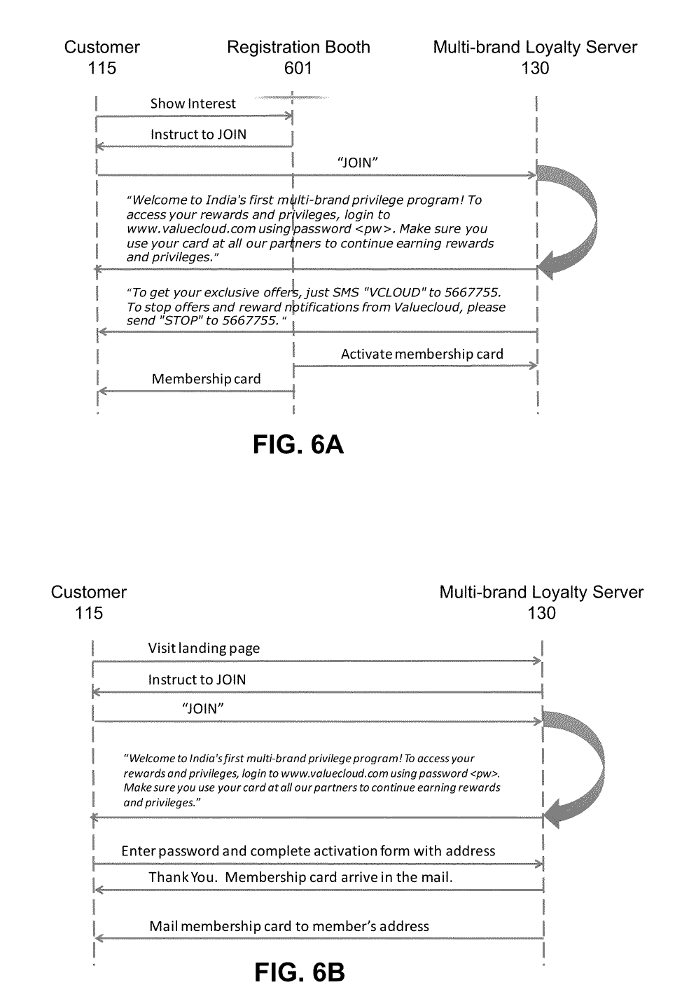

FIGS. 6A-6B are diagrams illustrating different ways to register members. FIG. 6A illustrates a flow diagram for an exemplary embodiment of an in person registration, such as registering through a registration booth 601 located at a shopping mall. A customer 115 may show interest in the multi-brand loyalty service by approaching the registration booth. The user receives instructions to join the multi-brand loyalty service. For example, the instructions to join may include providing personal information such as name, address, phone number, and the like. The instructions may also include, for example, sending an SMS message to the multi-brand loyalty server 130 with the word “JOIN.”

After receiving the SMS, the multi-brand loyalty server 130 may reply with a welcome message and/or with instruction on how to use the service. As shown in FIG. 6A, the multi-brand loyalty server may reply with a welcome message
“Welcome to India's first multi-brand privilege program! To access your rewards and privileges, login to www.valuecloud.com using password <pw>. Make sure you use your card at all our partners to continue earning rewards and privileges.”
   and/or a instruction message
“To get your exclusive offers, just SMS “VCLOUD” to U.S. Pat. No. 5,667,755. To stop offers and reward notifications from Valuecloud, please send “STOP” to 5667755.”
   Finally, a membership card is activated and handed to the customer 115. In one embodiment, the activation of the membership card includes registering the membership card or membership number associated with the card to the personal information provided by the customer 115.

FIG. 6B illustrates a flow diagram for an exemplary embodiment of an online registration. The customer 115 visits a landing page associated with the multi-brand loyalty service and the multi-brand loyalty server 130 provides the customer 115 with instructions to join the service. For example, the instructions to join may include providing personal information such as name, address, phone number, and the like. The instructions may also include, for example, sending an SMS message to the multi-brand loyalty with the word “JOIN.” After receiving the SMS, the multi-brand loyalty server 130 may reply with a welcome message and/or with instruction on how to use the service.

In some embodiments, after sending a SMS message with the word “JOIN” to the multi-brand loyalty server 130, the server may create a new account, assign a temporary password to the customer 115 and send the temporary password to the customer 115. Using this temporary password, the customer 115 may be able to login to the multi-brand loyalty server 130 and activate the account. In one embodiment, after activating the account, the multi-brand loyalty service may send a membership card to the customer through a postal service.

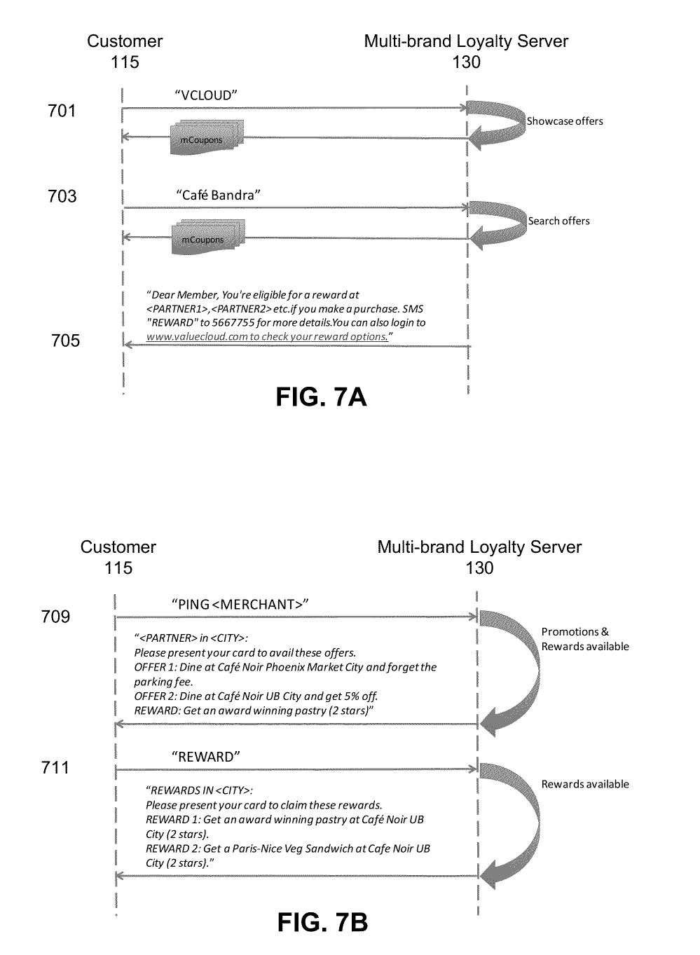

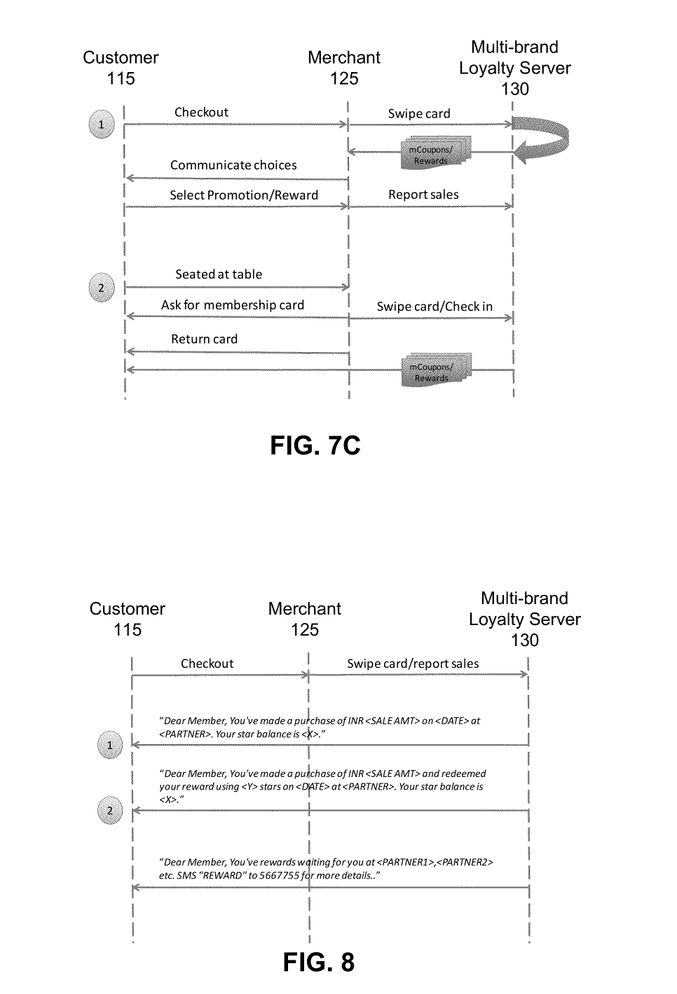

FIGS. 7A-7C are diagrams illustrating different ways to provide loyalty events. In some embodiments, a customer may request loyalty events by sending SMS messages to the server 130. For example, as shown in FIG. 7A, a user may request a loyalty event by sending an SMS with the word “VCLOUD” to the server 130. Customers 115 may also search for loyalty events by sending an SMS with a search query to the multi-brand loyalty server 130. For example, a customer 115 may send a search query with the word “café bandra” and the multi-brand loyalty server 130 may search for loyalty events for the merchant “café bandra.”

As shown in FIG. 7B, other examples of search queries that can be performed by customers 115 include “PING <MERCHANT>,” which allows customers 115 to search for promotions and rewards for a specific merchant, and “REWARD,” which allows customers 115 search for rewards available to the customer 115. In some embodiments the multi-brand loyalty server 130 may also send periodic messages to customers 115 regarding available loyalty events and how to access those loyalty events.

As shown in FIG. 7C, the multi-brand loyalty server 130 may also provide loyalty events for customers while making a transaction. For example, a customer 115 may present his membership card to a sales clerk at a department store and the sales clerk may scan the membership card using the merchant loyalty device. The merchant loyalty device may communicate with the multi-brand loyalty server 130 and inform that the customer 115 is ready to checkout. The multi-brand loyalty server 130 may then send one or more loyalty events to the merchant loyalty device. The sales clerk may inform the customer 115 about the different loyalty events that are available. The customer 115 may chose one or more loyalty events and complete the transaction with the merchant 125. After completing the transaction, the merchant 125 may report the sales to the multi-brand loyalty server 130.

In another example shown in FIG. 7C, the multi-brand loyalty service may also be used in a restaurant. The customer may provide his membership card to a server when seated at a table. The server may scan the membership card using the merchant loyalty device. The merchant loyalty device may then communicate with the multi-brand loyalty server 130 and inform that the customer is eating at that restaurant. The multi-brand loyalty server 130 may then send loyalty events to the customer 115.

FIG. 8 is a diagram illustrating an example of reporting. After a customer 115 has completed a transaction with a merchant 125, the merchant 125 may report the sales to the multi-brand loyalty server 130. For example, the merchant 125, through the point of sale device 120, may send information to the multi-brand loyalty server 130 regarding the amount of the transaction and or the products or services associated with the transaction. The multi-brand loyalty server 130, may then determine and report to the customer 115 an amount of points or stars to be awarded to the customer 115 for making the transaction. Furthermore, the multi-brand loyalty server 130 may also send to the customer 130 information regarding loyalty events, as selected by the recommendation module 350, based on the transaction.

### Other

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for providing to a customer in real-time a loyalty event for a merchant network of merchants that subscribe to a loyalty service, the method comprising a computer system located remotely from the merchant subscribers performing the steps of:
receiving a customer identification from a merchant loyalty device located on premises at a first merchant subscriber, the customer identification identifying the customer;
receiving transaction data from a merchant transactions device located on premises at the first merchant subscriber, the transaction data comprising information about a transaction between the first merchant subscriber and the customer; and
in real time, determining a loyalty event within the merchant network based on the transaction data and sending a notification of the loyalty event to the customer's mobile device.

2. The method of claim 1, wherein the step of determining a loyalty event depends on a geographic location of the first merchant subscriber.

3. The method of claim 2, wherein the loyalty event is for a second merchant subscriber and the step of determining the loyalty event includes selecting the second merchant subscriber based on a geographic relation between the first and second merchant subscribers.

4. The method of claim 3, wherein the step of selecting the second merchant subscriber is limited to those merchant subscribers that are within a geographic search vicinity of the first merchant subscriber.

5. The method of claim 4, wherein the geographic search vicinity is defined as located within a same shopping area as the first merchant subscriber.

6. The method of claim 4, wherein the geographic search vicinity depends on the transaction data.

7. The method of claim 1, wherein the merchant network is limited to merchants located within a certain metropolitan area.

8. The method of claim 1, wherein the merchant network is limited to merchants that offer luxury brands and/or luxury services.

9. The method of claim 1, wherein the step of determining a loyalty event depends on a type of business transacted by the first merchant subscriber.

10. The method of claim 1, wherein the loyalty event is for a second merchant subscriber and the step of determining the loyalty event includes selecting the second merchant subscriber based on a relation between the types of business transacted by the first and second merchant subscribers.

11. The method of claim 1, wherein the step of determining a loyalty event depends on transaction data for past transactions for the customer.

12. The method of claim 1, wherein the step of determining a loyalty event depends on aggregate transaction data received for many customers and many transactions.

13. The method of claim 1, wherein the loyalty event is a promotion and the promotion must be redeemed within a certain time of the transaction between the first merchant subscriber and the customer.

14. The method of claim 1, wherein the step of receiving a customer identification comprises receiving at least one of: a phone number, a membership number, and a barcode of the membership number.

15. The method of claim 1, wherein the merchant transactions device is a point of sale device.

16. The method of claim 1, wherein the merchant transactions device and the merchant loyalty device are one device.

17. The method of claim 1 wherein the notification is sent to the customer's mobile device via short message service (SMS).

18. The method of claim 1 wherein the notification is sent to the customer's mobile device via a mobile application.

19. The method of claim 1 wherein the customer's mobile device is a mobile phone.

20. A multi-merchant loyalty server system for providing to a customer in real-time a loyalty event for a merchant network of merchants that subscribe to a loyalty service, the server system configured for:
receiving a customer identification from a merchant loyalty device located on premises at a first merchant subscriber, the customer identification identifying the customer;
receiving transaction data from a merchant transactions device located on premises at the first merchant subscriber, the transaction data comprising information about a transaction between the first merchant subscriber and the customer; and
in real time, determining a loyalty event within the merchant network based on the transaction data and sending a notification of the loyalty event to the customer's mobile device.

21. A non-transitory computer readable medium configured to store instructions executable by a computer system, the instructions for:
receiving a customer identification from a merchant loyalty device located on premises at a first merchant subscriber, the customer identification identifying the customer;
receiving transaction data from a merchant transactions device located on premises at the first merchant subscriber, the transaction data comprising information about a transaction between the first merchant subscriber and the customer; and
in real time, determining a loyalty event within the merchant network based on the transaction data and sending a notification of the loyalty event to the customer's mobile device.
